(19) United States
(12) Patent Application Publication
(10) Pub. No.: US 2022/0066798 A1
(43) Pub. Date: Mar. 3, 2022

(54) Remote Support Device

(71) Applicants: Timothy L. Kelly, Barrington, IL (US); Cody Neville, Indianapolis, IN (US)

(72) Inventors: Timothy L. Kelly, Barrington, IL (US); Cody Neville, Indianapolis, IN (US)

(21) Appl. No.: 17/006,885

(22) Filed: Aug. 30, 2020

(51) Int. Cl. G06F 9/451; H04L 29/08; G16Y 30/00; H04L 29/06

(52) U.S. Cl. CPC G06F 9/452; H04L 63/0428; G16Y 30/00; H04L 67/025

(57) ABSTRACT

A remote support device is disclosed. The device is configured to transmit digital data from another computer-enabled device from a remote location for viewing or controlling from a remote location. The device comprises an embedded cellular PC that connects to the internet via a communication device utilizing keyboard, video, and mouse. The embedded cellular PC is connected to a target device using a KVM Internet of Things technology as a pass through remote controller via video connection and USB. The device securely transmits the digital data such as digital videos or images or live or near real-time necessary videos or images to the target device from the remote location. The device provides end-to-end encryption to securely transmit the digital data. Further, the device is used in various fields to control a system remotely without requiring access to the local network or installing native software.

### BACKGROUND OF THE INVENTION

### A. Technical Field

The present invention generally relates to transmission devices. More specifically, the present invention relates to a digital video transmission device configured to transmit live or near real-time necessary videos or images from another computer-enabled device from a remote location for viewing or controlling from the remote location.

### B. Description of Related Art

With the increase of wired and wireless network and distributed computing environments, the need to transfer digital content between computing devices has increased. The widespread use of various computing devices and the internet has resulted in the creation and transfer of digital content. The storage of digital content on commonly used computer medium allows for easy generation and transfer of digital content. However, it requires local network access to transfer the digital content. For example, it has become popular to generate digital content such as photos or live videos using a digital camera and then to transfer the digital content onto computers. The computer software permits the user to manipulate the digital content. The user may then transfer the digital contents to friends using e-mail, or post the digital photos on a web site accessible on the World Wide Web.

Further, an emerging class of consumer electronics device products connect to a communication network, for example, home network and to the rendering devices in the home to allow the direct display of streamed internet multimedia content on one or more of the rendering devices. It requires an application software to be installed on a mobile device to transfer the digital content to other devices via the communication network.

In light of all the above-mentioned drawbacks, there is a need for a solution to transfer digital content/data over a collaborative set of wireless and/or satellite networks. Also, there is a need for a solution to transmit live or near real-time necessary video or images and control, from another computer-enabled device from a remote location for viewing or controlling from a remote location. Further, there is a need for a solution to control a system remotely without requiring access to the local network or installing native software.

### SUMMARY OF THE INVENTION

The present invention generally discloses transmission devices. Further, the present invention discloses a digital video transmission device configured to transmit live or near real-time necessary videos or images from another computer-enabled device such as a computed tomography CT, magnetic resonance imaging MRI, Ultrasound, Lathe, Robotics, workstation, server, etc from a remote location for viewing or controlling from the remote location.

According to the present invention, the device is an innovative and intelligent product that has been designed for reliable digital data transmission over a communication network. In one embodiment, the device transmits digital data along with keyboard and mouse control over the communication network. In one embodiment, the digital data could be, but not limited to digital videos or images or live or near real-time necessary videos or images. In one embodiment, the communication network could be, but not limited to, a collaborative set of wireless and/or satellite networks or internet.

In one embodiment, the device is well suited for use in transmitting live or near real-time necessary video or images and control, from another computer-enabled device from a remote location for viewing or controlling from a remote location. This is accomplished without installing any native software on the device to be controlled. In one embodiment, the device could be used in situations of service, training, updating equipment, troubleshooting, and any other reason to remotely control a system without requiring any local network access or installing native software.

In one embodiment, the remote control is achieved by a collaborative grouping of technical elements combined as a single device. The device comprises an embedded cellular PC, a video grabber, a KVM (keyboard, video, mouse) pass through, a Remote Desktop Protocols (RDP), a video/High Definition Multimedia Interface (HDMI), a Universal Serial Bus (USB)/PS2, and a target device which is not directly connected to the Internet. The device primarily connects to an internet by establishing a connection via a communication device utilizing keyboard, video, and mouse. In one embodiment, the internet could be a high-speed network such as 3G/4G/5G. In one embodiment, the internet connection is primarily achieved by cellular connection on a typical cellular contract for service. The cellular connection utilizes encryption by default. In another embodiment, transmission control protocol (TCP) could be utilized as a backup to the cellular connection. In one embodiment, the communication device could be, but not limited to, a mobile phone, a smartphone, a. tablet, a laptop, a personal computer, iPad, or other suitable electronic communication devices.

In one embodiment, the device uses a KVM Internet of Things (IoT) technology as a pass through remote controller via the embedded cellular PC connected to the target device which is not directly connected to the Internet via the video/HDMI connection and. USB/PS2. In one embodiment, the video/HDMI connection is established using, but not limited to, HDMI, miniature quick connect/disconnect radio frequency connector or Bayonet Neill-Concelman (BNC), Composite, S-Video, and Video Graphics Array (VGA) for videos. In one embodiment, the USB/PS2 is used for mouse (PS2) and keyboard control, In one embodiment, peer to peer connection protocols are also used for Remote Desktop Protocols (RDP) connection pass though control and video capture in real-time.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a remote support device configured to transmit live or near real-time necessary videos or images from another computer-enabled device in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

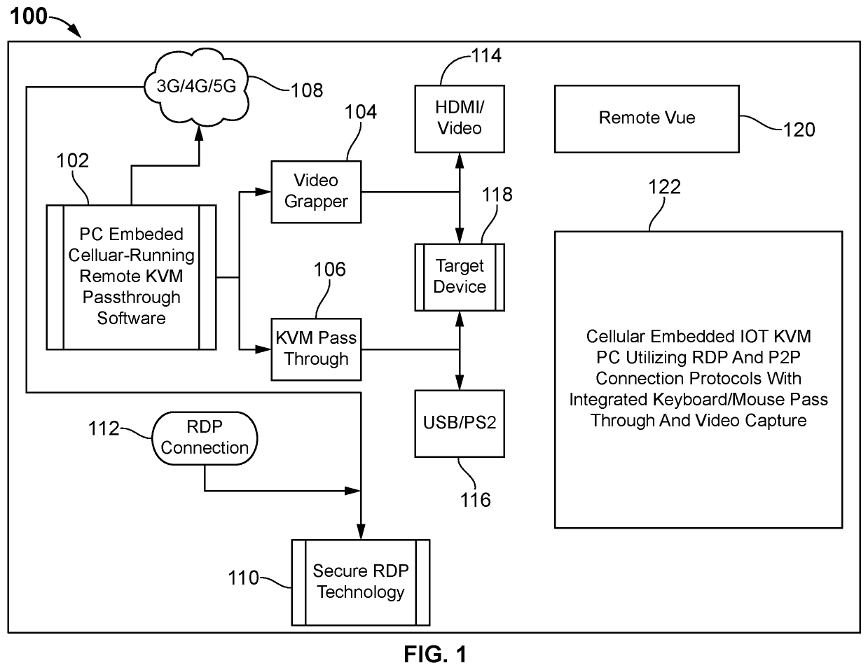

Referring to FIG. 1, a remote support device (hereinafter referred as device) 100 configured to transmit digital data from another computer-enabled device, according to an embodiment of the present invention. The computer-enabled device could be, but not limited to, CT, MRI, Lathe, Robotics, workstation, server, etc. The device 100 is an innovative and intelligent product that has been designed for reliable digital data transmission over a communication network. In one embodiment, the device 100 transmits digital data along with keyboard and mouse control over the communication network. In one embodiment, the digital data could be, but not limited to digital videos or images or live or near real-time necessary videos or images. In one embodiment, the communication network could be, but not limited to, a collaborative set of wireless and/or satellite networks or internet.

In one embodiment, the device 100 is well suited for use in transmitting live or near real-time necessary video or images and control, from another computer-enabled device from a remote location for viewing or controlling from a remote location. This is accomplished without installing any native software on the device to be controlled. In one embodiment, the device 100 could be used in situations of service, training, updating equipment, troubleshooting, and any other reason to remotely control a system without requiring any local network access or installing native software.

In one embodiment, the remote control is achieved by a collaborative grouping of technical elements combined as a single device 100. The device 100 comprises an embedded cellular personal computer PC 102, a video grabber 104, a KVM (keyboard, video, mouse) pass through 106, a Remote Desktop Protocols (RDP) connection 112, a video/High Definition Multimedia interface (HDMI) 114, a Universal Serial Bus (USB)/PS2 116, and a target device 118 which is not directly connected to the Internet. The device 100 primarily connects to the internet by establishing a connection via a communication device utilizing a keyboard, video, and mouse. In one embodiment, the internet could be a high-speed network such as 3G/4G/5G 108. In one embodiment, the internet connection is primarily achieved by cellular connection on a typical cellular contract for service. The cellular connection utilizes encryption by default. In another embodiment, transmission control protocol (TCP) could be utilized as a backup to the cellular connection. In one embodiment, the communication device could be, but not limited to, a mobile phone, a smartphone, a tablet, a laptop, a personal computer, iPad, or other suitable electronic communication devices.

In one embodiment, the device 100 uses a KVM Internet of Things (IoT) technology 122 as a pass through remote controller via the embedded cellular PC 102 connected to the target device 118 which is not directly connected to the Internet via the video/HDMI connection 114 and USB/PS2 116. In one embodiment, the video/HDMI connection 114 is established using, but not limited to, HDMI, miniature quick connect/disconnect radio frequency connector or Bayonet Neill-Concelman (BNC), Composite, S-Video, and Video Graphics Array (VGA) for videos. In one embodiment, the USB/PS2 116 is used for mouse (PS2) and keyboard control. In one embodiment, peer to peer connection protocols are also used for Remote Desktop Protocols (RDP) connection 112 pass though control and video capture in real-time.

In one embodiment, the embedded cellular PC 102 runs using remote KVM pass-through software. In one embodiment, the embedded cellular PC 102 is in communication with a secure RDP technology 110 via the internet, for example, 3G/4G/5G 108. Also, the RDP connection 112 is made to the secure RDP technology 110. The RDP connection 112 provides a use of a graphical interface to connect to another computer over the communication network. The embedded cellular PC 102 connects to the video grabber 104 and KVM pass through 106. In one embodiment, the video grabber 104 connects the embedded cellular PC 102 and the video/HDMI 114. In one embodiment, the output of the video grabber 104 is transmitted to the video/HDMI 114 and target device 118.

In one embodiment, the output of the KVM pass through 106 is connected to the USB/PS2 116 and target device 118 which it is not directly connected to the Internet. In one embodiment, the USB/PS2 116 has a USB controller, into which a USB memory stick or device could be deployed to transfer data or files form embedded cellular PC 102 to target device 118 via USB input without direct connection by embedded cellular PC 102. In another embodiment, the device 100 could use a cellular embedded IoT KVM PC 122 utilizing RDP connection 112 and peer to peer P2P connection protocols with integrated keyboard/mouse pass through and video capture. In one embodiment, the device 100 provides a remote view 120 to transmit digital content along using KVM over the collaborative set of communication networks.

According to the present invention, the device 100 is a remote access device or remote service product that provides a rapid response service. The device 100 allows service organizations to remotely access and control the equipment without the use of any third-party application software on the target device 118. During use, the device 100 plugs into the video/HIM or video out port 114 and the USB/PS2 or USB port 116. Once the device is connected, the service provider could log-in and view the device's screen in real-time and control the keyboard and mouse allowing for full equipment access. Allowing organizations to walk a customer through a setup or troubleshoot and fix an issue could reduce the amount of expensive on-site service calls.

The device 100 has an embedded cellular connection, which is quick and easy to deploy. Optionally, an Ethernet connection is deployed as a backup network connection. The pass through hardware components has certifications such as FCC compliance statement 47 CFR section 2.1077, CE Compliance, Directive 2014/30/EU—Electromagnetic Compatibility Directive 2011/65/EU, RoHS, and restriction of the use of certain hazardous substances in electrical and electronic equipment. The device CPU has the following certifications and specifications: 2002/96/EC (WEEE Directive). 2011/65/EU (RoHS 2 Directive), CE, EN 55024, EN 55032, EN 60950-1, EN 62368-1, FCC 47 CFR Part 15, and IPSO. The computer processing unit CPU has an input voltage of about 12V. The CPU has a power input DC jack. Further, the CPU has an operating temperature ranges from about 0° C. to about 40° C.

The target device 118 supports the generic keyboard and mouse. Further, the target device requires the input USB port. The video output could be, but not limited to, HDMI, digital video interface DVI, and/or VGA. The device 100 could send and receive files via the USB connection up to 32 GB. The device 100 could have an onsite button, which is pushed to allow the file transfer with added security.

The device 100 has a security architecture that allows the device 100 to traverse in different environments. The security architecture of the device 100 has, but not limited to the following security features and strategies.

### Data Storage:

The device 100 does not store or record any PHI during the connection.

### TCP Connection Methods:

While connecting to a cloud server, the cloud server services only broker approved connections and acts as a fallback transport mechanism for the encrypted data. Further, the ultimate responsibility for authorizing remote access lies solely with the device's cloud server.

### Remote FrameBuffer (RFB) Protocol:

SonicRapid Response technology uses the Remote Framebuffer Protocol (RFB). RFB is an Internet-Standard protocol originally created by the company RealVNC as the first remote desktop protocol (RDP). RealVNC continues to actively maintain this, and RFB 5 is released, designed from the ground up to support cloud connectivity. RFB 5 mandates the use of modern cipher suites and uses strong cryptography. it is streamlined compared to transport layer security TLS, making it much less prone to implementation vulnerabilities and misconfiguration. It offers very strong key exchange that is designed for cloud connectivity, by mixing in three sources of key material includes the local client, the remote client, and the cloud handshake. It puts the clients in full control of encryption keys to prevent tampering.

### Encryption:

The device 100 uses advanced encryption standard AES-GCM encryption to ensure the secrecy and integrity of data during data transmission. Further, the rapid response subscription types support 256-bit AES, wherein all encryption is end-to-end.

### User Authentication:

The device 100 allows a user to create a rapid response account, which is secured using email as a second factor. All users are required to create an account with a secure password. As an added security feature, scalable source routing SSR has to approve all users and sets all contacts within each account allowing only approved users to have access to the medical device. Each time the user sign in online or inform a new device at a new location, the user will get an email requiring to confirm their activity. The email records the time, location, and type of device attempting to access the user's account. This ensures that people cannot sign in to other user's account even if they discover or guess the other user's rapid response account credentials such as email address and password. A device is subsequently remembered so the user is not required to confirm on that device again, nor on any other device at the now-trusted location, unless the user explicitly chooses to forget.

### Network:

The components of the device 100 use cellular service to transmit the data allowing easy install and added security staying off the core network.

### Rapid Response Connection to Target Device:

Rapid Response connection to the target device 118 occurs over a hardwired secured connection. The device 100 takes the video out of the video output and establishes the USB connection 116 acting as a pass through for keyboard and mouse strokes or KVM pass through 106. No software is needed to be installed on the target device 118. The device 100 has a button that switches hard drive access to and from the target device 118. Without interaction from the device 100 (button Push), no data can be pulled or pushed for added security, even though the device 100 is connected through USB 116 to the target device 118. The target device 118 does not network facing. The USB connection 116 from the ultrasound is not directly plugged into the CPU. It is plugged into a separate hardware device that only allows keyboard and mouse strokes. That device then establishes a connection with the network-facing CPU, The target device 118 never directly touches an external network.

### Audit:

The device 100 writes an audit entry to each platform's system log for every connection made and in-store in Azure cloud storage with advanced encryption enabled.

Further, the remote support device is designed to be effective in the application. The device is a portable remote controller. The device could be used in various fields such as medical, manufacturing, training, and other industries without having to add a device to local network and security protocols. Further, the device is a self-contained universal controller. The user benefits from improved ease of use and improved security, which could provide considerable market interest in the product.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1) A digital video transmission device configured to transmit digital data, comprising:
a communication network for transmitting the digital data with keyboard and mouse control;
a remote computer located at a remote location connected to the communication network for transmitting the digital data with keyboard and mouse control to a target device which is not directly connected to an Internet;
wherein the remote computer controls the target device from the remote location.

2) A digital video transmission device configured to transmit digital data as in claim 1, wherein the remote computer includes a video grabber to download video for transmission.

3) A digital video transmission device configured to transmit digital data. as in claim 1, wherein the remote computer includes a KVM device to switch between the remote computer and the target computer.

4) A digital video transmission device configured to transmit digital data as in claim 3, wherein the KVM device switches between a first mouse and a second mouse.

5) A digital video transmission device configured to transmit digital data as in claim 3, wherein the KVM device switches between a first keyboard and a second keyboard.

6) A digital video transmission device configured to transmit digital data as in claim 3, wherein the KVM device which is between a first video source and a second video source.

7) A digital video transmission device configured to transmit digital data as in claim 3 wherein the KVM device includes a remote desktop protocol (RDP) to provide a graphical interface with the target computer.

8) A digital video transmission device configured to transmit digital data as in claim 3, wherein the KVM device includes a high definition multimedia. interface.

9) A digital video transmission device configured to transmit digital data as in claim wherein the communication network connects to an Internet.

10) A digital video transmission device configured to transmit digital data as in claim 9, wherein the Internet is a high-speed network with at least a 3G speed.

11) A digital video transmission device configured to transmit digital data as in claim 1, wherein the communication network includes a cellular connection.

12) A digital video transmission device configured to transmit digital data as in claim 11, wherein the cellular connection includes encryption.

13) A digital video transmission device configured to transmit digital data as in claim 1, wherein the communication network includes a transmission control protocol (TCP).

14) A digital video transmission device configured to transmit digital data as in claim 1, wherein for transmitting the digital data with keyboard and mouse control to a target device is transmitted without installing native software on the target device or local network access.

15) A method to transmit digital data, comprising the steps of:
transmitting the digital data with keyboard and mouse control;
transmitting the digital data with keyboard and mouse control to a target device which is not directly connected to an Internet from a remote computer enabled device located at a remote location;
controlling the target device from the remote computer located at the remote location.

16) A method to transmit digital data as in claim 15, wherein the method includes the step of operating a video grabber to download video for transmission.

17) A method to transmit digital data. as in claim 15, wherein the method includes the step of operating a KVM device to switch between the remote computer and the target computer.

18) A method to transmit digital data as in claim 1.5, wherein the method includes the step of operating the KVM device to switch between a first mouse and a second mouse.

19) A method to transmit digital data as in claim 15, wherein the method includes the step of switching the KVM device between a first keyboard and a second keyboard.
